(19) United States
(12) Patent Application Publication
(10) Pub. No.: US 2006/0252553 A1
(43) Pub. Date: Nov. 9, 2006

(54) Video game stand device

(76) Inventor: Larry S. Goode, Woodbridge, VA (US)

Correspondence Address: KLIMA LAW OFFICES, P.L.L.C., P.O. Box 2855, Stafford, VA, 22255-2855, US

(21) Appl. No.: 11/124,111

(22) Filed: May 9, 2005

(51) Int. Cl. G06F 19/00

(52) U.S. Cl. 463/47

(57) ABSTRACT

A video game stand device. In a preferred embodiment, the video game stand device includes a base portion, a tower portion and a platform portion. Preferably, the platform portion can be adjustable in both height and angle relative to the floor.

### FIELD OF THE INVENTION

The present invention is directed to a video game stand device. For example, the video game stand device according to the present invention can include one or more video game controllers such as a racing wheel, foot pedals, flight stick and joystick of a video game system.

### BACKGROUND OF THE INVENTION

Currently, there exists a number of video game systems or players such as X-Box, PlayStation, Nintendo and personal computers (PC). These game systems all offer numerous games involving racing cars, motorcycles, seadoos, skiing, snow boarding and other sports or activities that can be operated by a racing wheel, foot pedal, flight stick and/or joystick video game controller connected to the game system.

Typically, a user places the steering wheel, flight stick, or joystick on a desktop or tabletop to support the racing wheel, flight stick, or joystick during use and places the foot pedals on the floor under the desk or table. The user sits at a chair by the desk or table during operation of the game system using the steering wheel or joystick located on the desktop or tabletop. The application of the racing wheel, flight stick, or joy stick on top of a conventional desk or table works fairly well, however, the racing wheel, flight stick, joystick, foot pedals and game system tie up the use of the desk or table from other activities sometimes for extended periods of time.

Further, the use of a conventional desk or table for supporting the racing wheel, flight stick, or joystick is not optimal, since the height of the desktop or tabletop is fixed, and usually the desktop and tabletops are horizontal surfaces relative to the floor. Thus, the user has the inability to adjust the height and/or angle of the desktop or tabletop to improve comfort, efficiency and operability of the racing wheel, flight stick, or joystick.

The present invention is directed to a standalone and dedicated video game stand device configured to accommodate a racing wheel, flight stick, joy stick and/or foot pedals for various video game systems, and provides numerous advantages and improvements over using a conventional desk or table for supporting these video game controllers.

### SUMMARY OF THE INVENTION

A first object of the present invention is to provide a video game stand device.

A second object of the present invention is to provide a standalone video game stand device.

A third object of the present invention is to provide a dedicated video game stand device.

A fourth object of the present invention is to provide an improved video game stand device.

A fifth object of the present invention is to provide a video game stand device including a platform portion configured for supporting a video game controller, and the platform portion being adjustable in height.

A sixth object of the present invention is to provide a video game stand device including a platform portion configured for supporting a video game controller, and being adjustable in angle.

A seventh object of the present invention is to provide a video game stand including a platform portion configured for supporting a video game controller and being adjustable in both height and angle.

A eighth object of the present invention is to provide a video game stand device including a base portion, a tower portion connected to the base portion and a platform portion connected to the tower portion, the platform portion being configured for supporting a video game controller and being adjustable in height and/or angle.

A ninth object of the present invention is to provide a video game stand device, including a base portion; a tower portion connected to and extending upwardly from the base portion; a platform portion supported by the tower portion and configured for supporting a video game controller, the platform being connected to the tower portion by a hinged type connection; and configured to allow the platform to be set at different angles relative to the tower portion; and an angle adjustment device for changing and setting the platform portion at different angles relative to the tower portion.

A tenth object of the present invention is to provide a video game stand device, including a base portion; a tower portion connected to and extending upwardly from the base portion, the tower portion including a pair of flat side panels connected together by a flat back panel defining a cavity with the tower portion and accessible from a front of the tower portion, the tower portion including a flat top panel defining a slot between an upper edge of the flat back panel and a lower surface of the flat top panel; a flat platform portion supported by the tower portion, the platform portion including a handle portion at one end, the handle portion configured to cooperate with and fit into the slot of the tower portion to provide a hingeless connection therebetween; and an angle adjustment device for changing and setting the platform portion at different angles relative to the tower portion or floor.

A eleventh object of the present invention is to provide a video game stand device, including a base portion; a tower portion connected to and extending upwardly from one end of the base portion, the tower portion including a pair of flat side panels connected together by a flat back panel defining a cavity accessible from a front of the tower portion, the flat side panel having inclined upper edges, the tower portion including a flat top panel defining a slot between an upper edge of the flat back panel and a lower surface of the flat top panel; a flat platform portion supported at one end by the tower portion, the platform portion and the base portion extending away from the tower portion in a same direction, the platform portion including an upper flat platform panel connected to lower flat platform panel having a handle portion provided at one end thereof, the handle portion configured to cooperate with and fit into the slot of in the tower portion to provide a hinge connection therebetween, the lower flat platform panel of the platform portion fitting between the inclined upper edges of the flat side panels; and an angle adjustment device for changing and setting the platform portion at different angles relative to the tower portion or floor, the angle adjustment device including a pair of slidable wedges disposed between the inclined upper edges of the flat side panels and lower surface portions of the upper flat platform panel of the platform portion, the movable wedges being slotted and slidably connected to the lower surface portion of the upper flat platform panel of the platform portion.

A twelfth object of the present invention is to provide a video game stand device including a tower portion having a pair of flat side panels connected together by a flat back panel defining a cavity within the tower portion and accessible from a front of the tower portion.

A thirteenth object of the present invention is to provide a video game stand device including a tower portion having at least one shelf disposed within a cavity of the tower portion, and accessible from a front side of the device.

A fourteenth object of the present invention is to provide a video game stand device wherein the tower portion includes at least one slidable shelf disposed within a cavity of the tower portion when closed, and accessible from a side of the device when opened.

A fifteenth object of the present invention is to provide a video game stand device including a tower portion having a one fixed shelf and a slidable shelf disposed within a cavity of the tower portion when closed, and accessible from a side of the device when opened.

A sixteenth object of the present invention is to provide a video game stand device including a rack or shelf(ves) provided on a backside of the tower portion for storing at least one video game.

A seventeenth object of the present invention is to provide a video game stand device including a rack or shelves is configured for storing multiple video games.

A eighteenth object of the present invention is to provide a video game stand device including a rack provided on a backside of a tower portion for storing at least one video game.

A nineteenth object of the present invention is to provide a video game stand device including a cup holder provided on a side of a tower portion.

A twentieth object of the present invention is to provide a video game stand device including a pair of flat side panels provided with inclined upper edges cooperating with a platform portion.

A twenty first object of the present invention is to provide a video game stand device including an angle adjustment device having a pair of slidable wedges disposed between inclined upper edges of the flat side panel of a tower portion and lower surface portions of a platform portion.

A twenty second object of the present invention is to provide a video game stand device including a platform portion configured for supporting a racing wheel video game controller.

A twenty third object of the present invention is to provide a video game stand device including a base portion defining a floor of a cavity of a tower portion for accommodating a foot pedal video game controller.

A twenty fourth object of the present invention is to provide a video game stand device including a base portion defining a floor of a cavity of a tower portion for accommodating a foot pedal video game controller and a platform portion for accommodating a racing wheel or joy stick video game controller.

A twenty fifth object of the present invention is to provide a video game stand device including a platform portion removably connected to a tower portion.

A twenty sixth object of the present invention is to provide a video game stand device including a platform portion hingedly connected to a tower portion without the use of a separate hinge unit.

A twenty seventh object of the present invention is to provide a video game stand device including a platform portion hingedly connected to the tower portion with a separate hinge unit.

A twenty eighth object of the present invention is to provide a video game stand device including a platform portion hingedly connected to a tower portion in a manner that both the height of the platform portion and angle of the platform portion relative to the tower portion are changed when adjusting the platform portion relative to the tower portion. The present invention is directed to a video game stand device. The video game stand device Are preferably a standalone unit and/or a dedicated unit for accommodating one or more game video controllers such as a joy stick video game controller, racing wheel video game controller and/or foot pedal video game controller.

The present invention is directed to a video stand device. The game stand device is preferably a standalone unit and/or a dedicated unit for accommodating one or more video game controllers such as a racing wheel, foot pedals, flight stick and a joystick.

The video game stand device according to the present invention includes at least a tower portion and a platform portion supported by the tower portion. In a preferred embodiment, a base portion is connected to the tower portion for stabilizing the video game stand device.

In a preferred embodiment, the platform portion is adjustable in height and/or angle relative to the tower portion or floor on which the video game stand device is situated. This allows a user to adjust the video game stand device for his or her comfort and enhanced operational use of the one or more video game controllers supported by or provided on the video game stand device.

The tower portion is preferably constructed of two flat side panels connected together by a flat back panel. The tower portion can be made as a single piece unit (e.g. injection molded out of plastic, constructed of a single sheet of bent or formed metal or plastic, fiberglass molded), or can be assembled together from separate pieces (e.g. plastic panels or wood composite board panels). Preferably, the front of the tower portion is left open to provide a cavity therein accessible from the front of the video game stand device. The floor of the cavity is defined by the base portion providing a floor for a video game foot pedal controller. The side panels and back panel of the tower portion restrict or trap the video game pedal controller during use to restrict movement (e.g. sliding) thereof.

The tower portion can be provided with one or more racks or shelves. For example, a fixed shelf can be provided at a particular height within the cavity of the tower portion, and accessible from the front of the video game stand device. In addition, or alternatively, a slidable shelf can be provided that is accommodated at a particular height within the cavity of the tower portion when closed, and accessible from the side of the tower portion when opened. A pair of slides (e.g. upper and lower guides or dowels) connected to and supported by the flat side panels of the tower portion can cooperate with end plates of the slidable shelf provided with sets of through holes to accommodate the dowels or slides. A handle can be provided on one end of the slidable shelf to assist in opening and closing the slidable shelf due to the one end panel being flushed mounted with the side of the tower portion.

The video game stand device includes a platform portion configured for supporting a racing wheel, flight stick, or joystick video game controller. For example, the platform portion can be made substantially flat to provide a horizontal work surface to allow the racing wheel, flight stick, or joy stick video game controller to sit or rest thereon. In a preferred embodiment, the platform portion is movably relative to the tower portion. For example, the platform portion can be connected to the tower portion so that the platform portion can be raised or lowered to different heights. For example, the back panel of the tower portion can be provided with multiple slots located at different heights. Further, the platform portion can be connected to the tower portion so that the angle of the platform portion relative to the tower portion or floor can be changed. In preferred embodiments, the height and angle of the platform portion can be changed independently or dependently. For example, the platform portion can be mounted cantilever to the tower portion so that when the angle between the platform portion and tower portion is changed, the height of the platform portion, particularly at the free end thereof, changes with the change of angle. In this manner, a user can simultaneously change the height and angle of the platform portion so as to be comfortable and optimized the user's ability to operate the particular video game controller. Further, in a preferred embodiment, the platform portion is removably connected to the tower portion.

In a preferred embodiment, the platform portion is hinged relative to the tower portion. The hinge can be provided by a joint or connection between the platform portion and tower portion that allows movement therebetween without the necessity of a separate hinge component or unit. Alternatively, one or more separate hinge component or unit (e.g. hinge strip) can be utilized to connect the platform portion to the tower portion, however, making it more difficult or impossible to remove the platform portion from the tower portion.

The video game stand device according to the present invention is preferably provided with an angle adjustment device connected to, located adjacent, disposed between, or otherwise mechanically connected in some manner and configured to allow the platform portion to be changed angle relative to the tower portion. For example, a pair of slidable wedges, preferably resilient wedges (e.g. made of plastic or rubber material) are disposed between the upper inclined edges of the side panels of the tower portion and the bottom surface portions of the platform portion. When the slidably wedges are moved, the angle of the platform portion relative to the tower portion is changed. The wedges can be provided with a slot cooperating with a set of fasteners (e.g. screws) or separate guides to allow the wedges to be slid back and forth between the upper edges of the side panels of the tower portion and the bottom surface portions of the platform portion.

In a preferred embodiment, a cup holder is provided on one or both sides of the tower portion.

The video game stand device according to the present invention can be made from a variety of materials including wood, plastic, fiberglass, metal, composite wood board, composite plastic board, metal panels, and plastic sheet. However, composite wood board, particleboard or pressboard is preferably used for construction of the base portion, tower portion, and platform portion. For example, the composite boards can be cut to length and shape, and then connected together by adhesive, screws, mechanical fasteners or combinations thereof. Further, a variety of different types of finishers and/or coatings can be applied to provide a suitable, durable and aesthetically good looking quality finish.

The video game stand device according to the present invention preferably is provided with a pair of wheels or casters for moving the device from one location to another. Specifically, a pair of wheels or coasters can be attached to the backside and at the bottom of the tower portion, and are positioned so as to come into contact with the floor when the video game stand device is tilted using the handle portion of the platform portion.

### BRIEF DESCRIPTION OF THE DRAWINGS

FIG. 1 is a perspective view of a preferred embodiment of a video game stand device according to the present invention.

FIG. 2 is a front elevational view of the video game stand device shown in FIG. 1.

FIG. 3 is a back elevational view of the video game stand device shown in FIG. 1.

FIG. 4 is a left side elevational view of the video game stand device shown in FIG. 1.

FIG. 5 is a right side elevational view of the video game stand device shown in FIG. 1.

FIG. 6 is a partial broken away detailed side elevational view of an angle adjustment device for tilting the platform portion relative to the tower portion.

FIG. 7 is a partial broken away cross-sectional view of the angle adjustment device, as indicated in FIG. 6.

FIG. 8 is a partial broken away detailed front elevational view of the sliding drawer of the tower portion.

FIG. 9 is a diagrammatic perspective view of the video game stand device shown in FIG. 1 in combination with a chair and viewing monitor or television.

### DETAILED DESCRIPTION OF PREFERRED EMBODIMENTS

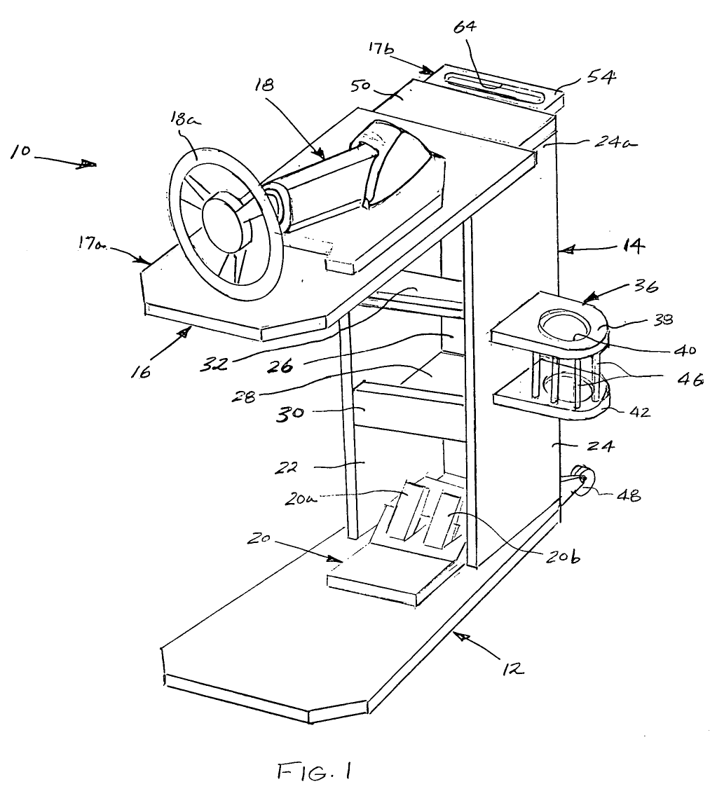

A preferred embodiment of a video game stand device 10 according to the present invention is shown in FIGS. 1-8.

The video game stand device 10 includes a base portion 12, tower portion 14 and platform portion 16. The base portion 12 is cantilever mounted to the tower portion 14, and the platform portion 16 is cantilever mounted to the tower portion 14. Further, the platform portion 16 and base portion 12 extend from the tower portion 14 in the same direction, or orientation so that the platform portion 16 overlaps or covers the base portion 12.

The base portion 12 is preferably a flat panel, and is sufficiently long and wide so as to provide a stable platform for the remainder of the video game stand device 10. During use, the base portion 12 is in contact with and supported by the floor or flooring (e.g. vinyl tiles, tile, carpeting, wood flooring).

The video game stand device in some embodiments is a separate unit not provided with any video game controller and/or video game system. In other embodiments, the video game stand device includes one or more video game controllers such as the racing wheel video game controller, pedal video game controller, flight stick video game controller, joystick video game controller and/or one or more video game systems.

In the video game stand device 10 shown in FIG. 1, a racing wheel video game controller 18 sits on top of and is supported by the platform portion 16, and a pedal video game controller 20 sits on and is supported by the base portion 12. Alternatively, another type of video game controller can be provided on the platform portion 16.

The tower portion 14 includes a left side panel 22, and a right side panel 24 connected together by a back panel 26. For example, the panels can be fastened together by mechanical fasteners (e.g. nails, screws) and/or adhesive (e.g. glue) when constructing the tower portion 14 out of separate wood composite panels. Alternatively, the tower portion 14 can be made as a single unit (e.g. plastic injection molded, molded fiber glass, bent metal or bent or formed plastic panel).

The tower portion 16 is provided with a fixed shelf 28 having a front-end panel 30. Further, the tower portion 14 includes a slidable shelf 32 having a side end panel 34 provided with a knob 35. The right side panel 24 is provided with a cup or bottle holder 36 including an upper plate 38 having a through hole 40 and a lower plate 42 having a closed bottom 44, and connected together by dowels 46. A pair of wheels or casters 48 are connected to the back of the tower portion 14, and come in contact with the floor or flooring when the video game stand device 10 is tilted for moving from one location to another. The tower portion 16 is provided with a through hole 49 for accommodating a cable for the foot pedal video game controller 20.

The left side panel 22 and the right side panel 24 are provided with upper incline edges 22a, 24a, respectively. An upper panel 50 is connected to the incline upper edges 22a, 24a, of side panels 22, 24, respectively, and is positioned adjacent the back panel 26 of the tower portion 14. As shown in FIG. 3, there exists a slot 52 between the upper edge 26a of the back panel 26 and the lower edge 50b of the upper panel 50. The slot 52 accommodates a handle portion 54 of the platform portion 16.

The back of the tower portion 14 is provided with pairs of dowels 56 set at an incline relative to each other providing shelves for storing multiple video games. Alternatively, the dowels 56 can be replaced with separate panel-type shelves. The individual dowels 56 of the pairs of dowels are each set at a slightly differential height to provide an inclined shelf for the video games.

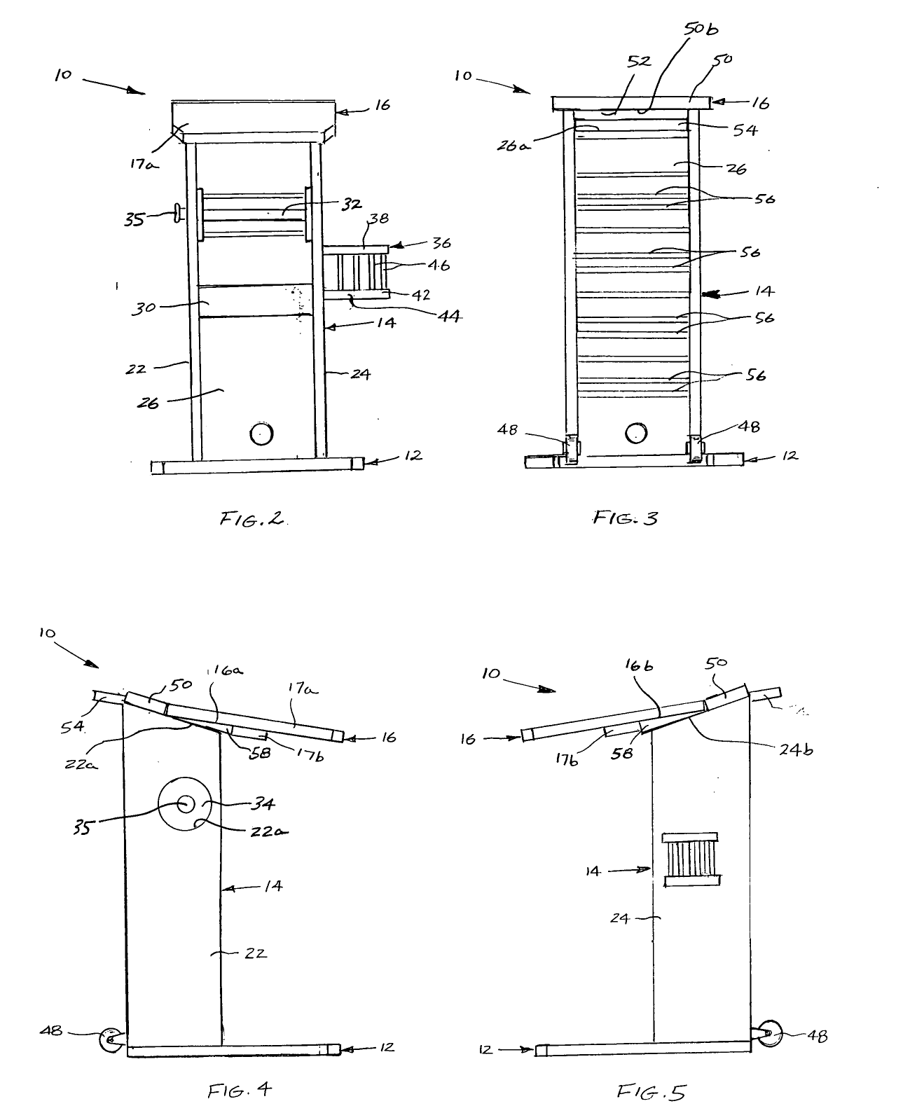

The platform portion 16 is removably connected to the tower portion 14 by sliding the handle portion 54 of the platform 16 through the slot 52 of the tower portion 14. An angle adjustment device is defined by a pair of wedges 58, as shown in FIGS. 4-6, disposed between the inclined upper edges 22a, 22b of left side panel 22 and right side panel 24, respectively, and bottom surface portions 16a, 16b of the platform portion 16. Preferably, the wedges 58 are made of a resilient rubber or plastic material to securely gripping the surfaces of the inclined upper edges 22a, 22b of the side panels 22, 24, respectively, and the bottom surface portions 16a, 16b of the platform portion 16. The wedges 58 are provided with a slot 60 (FIG. 7), and a pair of screw fasteners 62 fitted with washers 63 disposed within the slot 60 and connect the wedges 58 to the bottom surface portions 16a, 16b of the platform portion 16. In this manner, the wedges 58 can be moved forward or backward to change the angle of the platform portion 16 relative to the tower portion 14 or the floor.

Due to the cantilever arrangement of the platform 16 and tower portion 14, the front end of the platform portion 16 also moves upwardly and downwardly in height relative to the base portion 12 or floor when the angle of the platform portion 16 is changed. Thus, this arrangement allows for the platform portion 16 to simultaneously change angle and height of the platform portion 16 relative to the tower portion 14 or the floor. Thus, a user can quickly adjust the height and angle of the platform portion 16 in one step to make use of the racing wheel video controller 18 more comfortable and efficient depending on the height of the chair and/or the size and proportions of the body of the user.

In the embodiment shown, the platform portion 16 is not connected by a separate hinge to the tower portion 14, but is hingedly connected to the tower portion due to the configuration of the platform portion 14 and tower portion 14 (i.e. height of slot 54 provides adequate clearance to allow handle portion 54 of platform portion 16 to pivot relative to tower portion 14). Alternatively, the platform portion can be connected to the platform portion 14 by one or more separate hinges (e.g. platform portion 14 connected to front edge of upper panel 50 by one or more separate mechanical hinges or hinge strip).

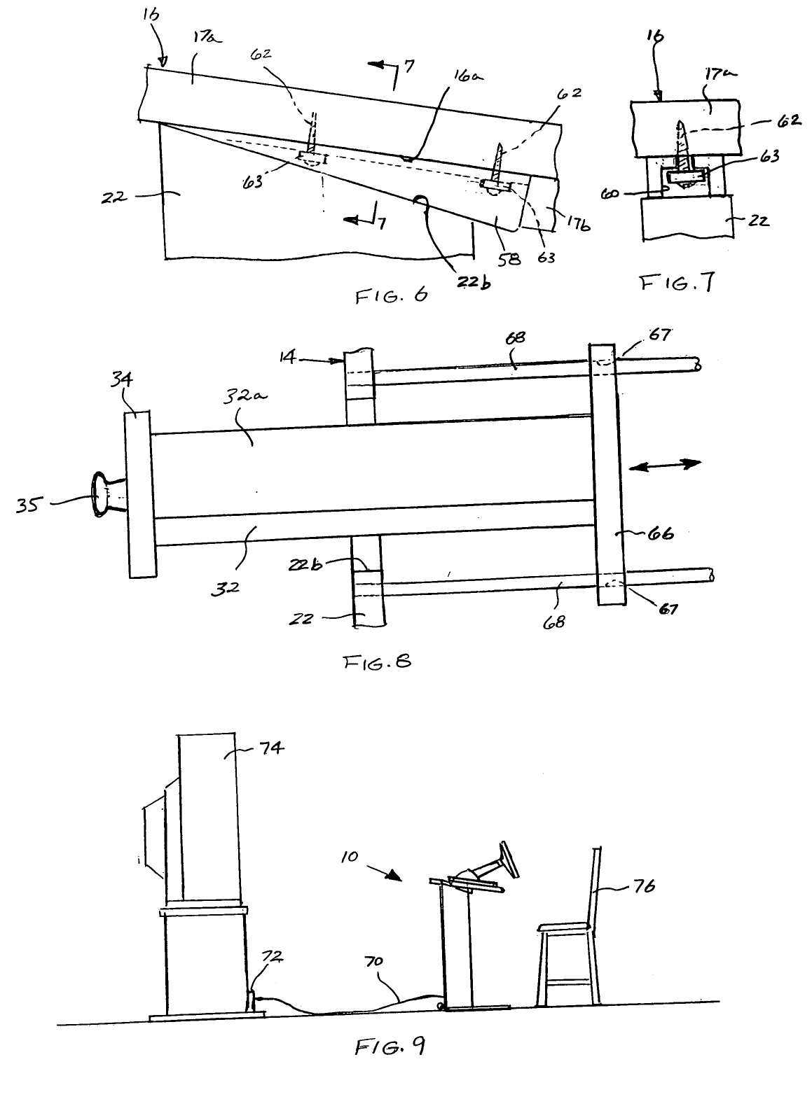

The platform portion 16 includes an upper platform panel 17a connected to a lower platform panel 17b, as shown in FIGS. 5 and 6. The platform panel 17a is wider than the tower portion 14. The lower platform panel 17b is less wide than the tower portion 14 and fits snuggly between the left side panel 22 and right side panel 24 of the tower portion 14. The upper platform panel 17a is connected to the lower platform panel 17b by mechanical fasteners and/or adhesive. The lower platform panel 17b is provided with a slot 64 defining the handle portion 54, as shown in FIG. 1.

The slidable shelf 32 moves left and right through the through hole 22b in the left side panel 22, as shown in FIG. 8. The slidable shelf 32 includes a back panel 32a and an end plate 66 provided with a pair of through holes 67 for slidably accommodating guides or dowels 68. The dowels 68 are connected between the left side panel 22 and the right side panel 24, and are anchored in holes (e.g. by interference fit and/or adhesive). The user grips the knob 35 and pulls the slideable shelf 32 in and out of the tower portion 14 of the video game stand device 10.

### Operation

The video game stand device 10 can be fully assembled or in kit form when acquired. At home or business, the user assembles the video game stand device 10, and then installs his or her racing wheel video controller 18, flight stick, and/or a joystick video game controller on top of the platform portion 16, and installs the foot pedal video game controller on the base portion 12 within the cavity of the tower portion 14.

The racing wheel video game controller 18 and the foot pedal video game controller 20 are connected by a cable 70 to the video game system 72. The video game stand device 10 is positioned in front of a television 74 for viewing the monitor, and then the user pulls up his or her chair 76 up in front of the video game stand device 10 ready to now operate and play the video game.

The user can adjust both the height and the angle of the racing wheel video game controller 18 by slightly lifting the free end of the platform portion 16 upwardly and then sliding the wedges 58, 58 forward or backwards on the inclined upper edges 24a, 24b of the left side panel 22 and right side panel 24, respectively, of the tower portion 14. Then, the user allows the free end of the platform portion 16 to drop down slightly so that the upper and lower surfaces of the wedges 58 are fully engaged and locked into position at the desired angle of the platform portion 16 relative to the tower portion 14. The video game is now ready to be played by the user.

I claim:

1. A video game stand device, comprising:
a base portion;
a tower portion connected to and extending upwardly from said base portion;
a platform portion supported by said tower portion and configured for supporting a video game controller, said platform being connected to said tower portion by a hinged type connection; and configured to allow the platform to be set at different angles relative to said tower portion; and
an angle adjustment device for changing and setting said platform portion at different angles relative to said tower portion.

2. A video game stand device, comprising:
a base portion;
a tower portion connected to and extending upwardly from said base portion, said tower portion including a pair of flat side panels connected together by a flat back panel defining a cavity with said tower portion and accessible from a front of said tower portion, said tower portion including a flat top panel defining a slot between an upper edge of said flat back panel and a lower surface of said flat top panel;
a flat platform portion supported by said tower portion, said flat platform portion including a handle portion at one end, said handle portion configured to cooperate with and fit into said slot of said tower portion to provide a hinge connection therebetween; and
an angle adjustment device for changing and setting said platform portion at different angles relative to said tower portion.

3. A video game stand device, comprising:
a base portion;
a tower portion connected to and extending upwardly from one end of said base portion, said tower portion including a pair of flat side panels connected together by a flat back panel defining a cavity within said tower portion and accessible from a front of said tower portion, said flat side panels having inclined upper edges, said tower portion including a flat top panel defining a slot between an upper edge of said flat back panel and a lower surface of said flat top panel;
a flat platform portion supported at one end by said tower portion, said platform portion and said base portion extending away and cantilevered from said tower portion in a same direction, said platform portion including an upper flat platform panel connected to lower flat platform panel having a handle portion provided at one end of said lower flat platform panel, said handle portion configured to cooperate with and fit into said slot in said tower to provide a hinge connection therebetween, said lower flat platform panel of said platform portion fitting between said inclined upper edges of said flat side panels; and
an angle adjustment device for changing and setting said platform portion at different angles relative to said tower portion, said angle adjustment device including a pair of slidable wedges disposed between said inclined upper edges of said flat side panels and lower surface portions of said upper flat platform panel of said platform portion, said movable wedges being slotted and slidably connected to said lower surface portions of said upper flat platform panel of said platform portion.

4. A device according to claim 1, wherein said tower portion includes a pair of flat side panels connected together by a flat back panel defining a cavity within said tower portion and accessible from a front of said tower portion.

5. A device according to claim 4, wherein said tower portion includes at least one shelf disposed within said cavity of said tower portion, and accessible from a front side of said device.

6. A device according to claim 4, wherein said tower portion includes at least one slidable shelf disposed within said cavity of said tower portion when closed, and accessible from a side of said device when opened.

7. A device according to claim 5, wherein said tower portion includes at least one slidable shelf disposed within said cavity of said tower portion when closed, and accessible from a side of said device when opened.

8. A device according to claim 1, including a rack provided on a back side of said tower portion for storing at least one video game.

9. A device according to claim 8, wherein said rack is configured for storing multiple video games.

10. A device according to claim 7, including a rack provided on a back side of said tower portion for storing at least one video game.

11. A device according to claim 1, including a cup holder provided on a side of said tower portion.

12. A device according to claim 4, wherein said pair of flat side panels are provided with inclined upper edges cooperating with said platform portion.

13. A device according to claim 12, wherein said angle adjustment device includes a pair of slidable wedges disposed between said inclined upper edges of said flat side members and lower surface portions of said platform portion.

14. A device according to claim 1, wherein said platform portion is configured for supporting a racing wheel video game controller.

15. A device according to claim 1, wherein said base portion defines a floor of said cavity of said tower portion for accommodating a foot pedal video game controller.

16. A device according to claim 14, wherein said base portion defines a floor of said cavity of said tower portion for accommodating a foot pedal video game controller.

17. A device according to claim 1, wherein said platform portion is removably connected to said tower portion.

18. A device according to claim 1, wherein said platform portion is hingedly connected to said tower portion without the use of a separate hinge unit.

19. A device according to claim 17, wherein said platform portion is hingedly connected to said tower portion with a separate hinge unit.

20. A device according to claim 1, wherein said platform portion is hingedly connected to said tower portion in a manner that both the height of said platform portion and angle of said platform portion are changed when adjusting the platform portion relative to said tower portion.
